(19) United States
(12) Patent Application Publication
(10) Pub. No.: US 2016/0203744 A1
(43) Pub. Date: Jul. 14, 2016

(54) LOW PROFILE SIMULATED 3D DISPLAY DEVICE

(71) Applicant: John Paul DUFFY, Toronto (CA)

(72) Inventor: John Paul DUFFY, Toronto (CA)

(21) Appl. No.: 14/976,571

(22) Filed: Dec. 21, 2015

Related U.S. Application Data
(60) Provisional application No. 62/103,358, filed on Jan. 14, 2015.

(51) Int. Cl. G09G 3/00

(52) U.S. Cl. CPC G09G 3/003; G09G 2300/023

(57) ABSTRACT

A low profile, simulated 3D display device comprising a front display device comprising a transparent front display device, arranged to display a first image of a first program material which is to be observed by a viewer, and a background display device arranged to display a second image of a second program material which is to be observed by a viewer, wherein said front display device and said background display device are separated to provide an apparent parallax effect between said first image and said second image, and wherein said background display device is a high-brightness video display device. The simulated 3D display device also optionally includes a moire artifact reduction screen to improve the quality of the simulated 3D image.

### PRIORITY

This application claims the benefit of priority from U.S. Provisional Application No. 62/103,358, filed Jan. 14, 2015, which is hereby incorporated herein by reference in its entirety.

### TECHNICAL FIELD

The present disclosure relates generally to a low profile, simulated three dimensional (3D) display device, and in particular, relates to a simulated 3D display device having improved picture quality and appearance, and which is both portable and scalable. The display device is adapted to display a simulated 3D video presentation which comprises a simulated 3D image comprising a virtual image on a front display, which is seen against a background display, wherein the background display may contain a further image which varies in a programmed manner in keeping with the actions being portrayed by the virtual image. As such, the present disclosure relates to apparatuses and devices which may be employed in theatrical, educational, or medical presentations, for example, and more particularly in advertising or other presentations which are intended to promote and/or extol the features and advantages of any product or service being offered for sale.

### BACKGROUND

The present disclosure finds its genesis in an theatrical illusion which is widely known as “Pepper's ghost”. In this illusion, a viewer is made to believe that he is seeing an article which does not, in fact, exist in the setting or circumstances being viewed. The techniques involved in presenting Pepper's ghost are described hereafter. However, for now, a brief description and history of Pepper's ghost is provided.

In order for the classical Pepper's ghost illusion to work properly, the viewer must see clearly into a main setting, but not see into a hidden room. Unknown to the viewer, the viewer is also viewing the main setting through an angled piece of glass which, because of its placement, may be both translucent and reflective. By changing the lighting in the hidden room, the viewer may view a reflection of the lit contents of the hidden room, on the glass panel. Thus, the illusion is controlled by its illumination, and will appear and disappear when the lighting of the object, person, or the like, is turned on or off, respectively. As a result, an object or person which is reflected in the “mirror” section of the glass (e.g. the reflective surface of the glass) may seem to appear or disappear, or change into another object. While this illusion is over 100 years old, the same effect has been employed since at least the 1960's in certain modern theme parks, where objects such as reflected animated props may create the appearance of translucent “ghosts” which appear to be moving through a particular setting and interacting with props in that physical particular setting. Moreover, the images appear to be three dimensional and demonstrate a parallax effect with respect to other items on the stage.

Typically, in recent applications, a polymeric film, drawn tight within a metal frame, is used to replace the glass panel, and a projection device is used to create the image to be displayed on the polymeric film. Construction of the film and associated frame, and the projectors to be used, are well known in the art, and outside of the scope of the present invention.

As an example, U.S. Pat. No. 8,172,400 (O'Connell et al.) describes a projection apparatus which requires a first projection device that is arranged to generate a virtual three dimensional object by projection of the image onto to a reflected/translucent polymer film. A second projection device projects a background image; and a light source projects light onto the virtual three dimensional image. A stage arrangement may also be provided, which is placed behind the screen, upon which a presenter or actor, or a prop, or both, may be located, in order that the presenter or prop, interact with the virtual image.

In more recent applications, such as those described in US Patent publication No. US 2013/0300728 (Reichow et al.), the polymeric film or glass panel showing the reflection is replaced by a transparent front display device, such as an transparent LCD display device. In this approach, the reflective surface with its projected image, is no longer required since the virtual image may be displayed directly on the transparent front display. A background display device is positioned visually behind the transparent front display, and a background image is shown or projected directly on the background display device. The images shown on the background display device may be coordinated with the images on the transparent front display in order to create an apparent parallax effect which provides images which are similar to images from the Pepper's Ghost technique.

Additional display panels may be provided between the front display and the background display, in order to provide additional image content. However, for simplicity, the use of a two panel approach will be discussed in the present document.

Current uses of this simulated 3D presentation technique may include, for example, the display of advertising materials in a simulated 3D environment, or the simultaneous presentation of a speech to numerous groups in many different locations, using a virtual image. Other applications have included providing a virtual performance by a performer, even though, in some cases, the performer is no longer alive.

However, unless a visual “ghost” effect is desired, it has typically been necessary to employ a black background surface behind the virtual image so as to avoid any background image showing through the virtual image. This is because if the viewer were to see the background image through the front image, it would destroy the “holographic” effect of the virtual image.

More recently however, the background image is adjusted so as to be coordinated with the transparent front image so that the two images are mated one to the other. As an example, a blacked-off “masked” area may be provided on the background display which masked image moves and/or is otherwise coordinated with the image on transparent front display so as to minimize or eliminate the background image from bleeding through the image on the front display.

In order to provide a simulated 3D effect using a front panel and a background panel (or any additional intermediate display panels), it is necessary to provide at least some distance between the transparent front display and the background display. This distance typically varies depending on the size of the display, and is used to create the parallax effect.

A common problem with this approach is that the light from the background panel is used to provide the lighting effect on the front panel. As such, with normal background panels and projection apparatuses, the combined 3D image is dark and/or dull, and is typically only useful in darkened display areas. While this is acceptable in some display areas, it is not practical for use in well-lit areas, such as in outdoor displays, or displays in a mall setting.

To address this issue, the prior art displays may be enclosed in a box so as to minimize the amount of ambient light that falls on the screen. However, these boxes require a relatively large profile, which increases the overall size of the screen, and thereby, limit their use in commercial applications. Also, because of the darkened box approach, typically only those standing directly in front of the box display may see the images on the screen. Thus, the ability to show the images to a larger group of people is limited.

A further problem with prior art display systems is the creation of an undesirable visual effect, call moire, wherein false patterns are observed in the final image, as a result of interaction between the visual display lines from the images on the front and background panels. These typically appear as a pattern of roughly parallel lines, or the like. This leads to unacceptable image quality, and is particularly prevalent in systems having lower image quality, or low resolution, display systems. Using higher resolution screens may therefore be expected to reduced the amount of moire observed in the combined image, however, this leads to an increased cost for the simulated 3D screen apparatus.

As such, it would be beneficial to provide a simulated 3D display device of the type described herein, wherein the screen apparatus is capable of being used in higher lighting situations. Furthermore, it would be beneficial to also provide a simulated 3D display device, having a low profile. Still further, it would be beneficial to also provide a simulated 3D display device which has been modified to reduce and/or ameliorate the moire effect, observed in other simulated 3D projection devices.

The present inventors have unexpectedly discovered that the at least some of these benefits may be provided in a novel, low profile simulated 3D display device, which may be viewed simultaneously by a plurality of viewers, in normal ambient lighting conditions.

### SUMMARY

An object of the invention is to provide a new and improved simulated 3D display device.

In an exemplary embodiment, a low profile, simulated 3D display device comprising a front display device comprising a transparent front display device, arranged to display a first image of a first program material which is to be observed by a viewer, and a background display device arranged to display a second image of a second program material which is to be observed by a viewer, wherein said front display device and said background display device are separated to provide an apparent parallax effect between said first image and said second image, and wherein said background display device is a high-brightness video display device.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for the purpose of illustration and description only and are not intended as a definition of the limits of the present disclosure. Embodiments of the present disclosure will now be described by way of example in association with the accompanying drawings in which:

FIG. 1 is a cut-away, perspective view of an exemplary embodiment of the present disclosure; and

FIG. 2 is a cross-sectional, top view of the exemplary apparatus shown in FIG. 1.

### DETAILED DESCRIPTION

In an exemplary embodiment, the high-brightness display device may have a brightness of at least 1500 maydelas per square meter. In another embodiment, the brightness may be more than 1750 maydelas per square meter. In another embodiment, the brightness may be at least 2000 maydelas per square meter (cd/m²). For comparison, typical high-definition televisions currently range from 450 to about 1000 cd/m².

At this lighting level, the exemplary background display device may be able to display not only its own image, it may also be able to light the image from the front display device, which typically, has no inherent emissive light qualities. Moreover, at this lighting level, the high-brightness video display device provides sufficient light to produce a bright overall screen image that may be easily viewed in normal ambient lighting conditions, such as the lighting conditions typically found in a commercial establishment, or a mall setting. Moreover, the high-brightness video display device may be selected so as to provide sufficient lighting such that simulated 3D display device consistent with exemplary embodiment of the present disclosure may be used outdoors, in natural sunlight.

The background display device may be any suitable display device, which may include a screen onto which an image may be projected (either from the front or rear). In an embodiment, the background display device may be a display device such as a television screen or monitor. These may include any suitable display devices, but preferably, flat panel display devices such as LCD, plasma, LED, OLED, and the like, may be used.

The background display device may also be comprised of a plurality of high-brightness display devices, wherein each of the display devices is preferably a television or a monitor. This may include televisions or monitors that are rear projection devices. In an embodiment, the rear screen may be chosen from the group consisting of a planar television tube, a planar plasma television display, a planar LCD television display, a planar LED television display, and a planar OLED television display. Other display devices might also be used as the rear screen, and the skilled artisan will be aware that their use is not precluded from the present disclosure.

In an exemplary embodiment, where a plurality of display devices are used, the background display may comprise a plurality of devices which are arranged to provide a completed background display. For example, 4 devices may be arranged in a planar 2×2 grid. Other arrangements are possible, and these may include 3×3 grids, 4×4 grids, 2×3 grids, 3×2 grids, or any other suitable arrangement.

The front display device may be a transparent display device. In an embodiment, the front display device is a flat panel, transparent LCD display device. In these types of devices, the panel itself has no light emissive properties, and the image from the first image of the first program material, is only lit from the light from the light from the background display device.

The simulated 3D display device of an exemplary embodiment of the present disclosure is scalable, so that overall size of the projected images may vary depending on their desired application. As such, the display device consistent with exemplary embodiments of the present disclosure is practical in small scale devices including computer monitors, smart phone displays, and the like, but may also be scaled upwards to include screens of up to 3 meters or more in height and/or width, for larger displays, such as those in theatres, display booths, or the like. In an exemplary embodiment, the screen size may be established by the size of the display devices, and thus, the screen size may be typically between 1 and 2 meters, in height and/or width. This would be suitable for use in commercial establishments, or in mall display boxes, but would also be suitable for home use, as a low profile, simulated 3D television device.

The distance between the front and background display panels may vary depending on the size of the panels. For applications wherein the front and/or background display panels have a height and/or width of 1 to 2 meters, the distance between the panels may preferably be between 2.5 and 20 cm, and more preferably between 5 and 10 cm. The distance between the panels may be optimized so as to provide the optimal apparent parallax effect.

As such, a typical 1 to 2 meter screen size, requires a depth of only approximately 25 cm, and preferably, of less than 20 cm. More preferably, the depth of the simulated 3D display device consistent with exemplary embodiments of the present disclosure, is less than 15 cm. As a result, the display device has a low profile, and is suitable for positioning on a wall, or inside of a thin cabinet. As such, it is well suited for commercial applications, such as in advertising boxes, or the like commonly found in a commercial establishment, or in a mall, or the like.

Moreover, the low profile of the present device, allows for easy transport and set-up of the device.

By way of example, in another exemplary embodiment of the present disclosure, the front and background display devices are permanently mounted in a case so as to be portable as a single structure, as will be hereinafter described. For this exemplary embodiment, the case will preferably be limited to a box having a length, height and width, of between 1.5 and 2.25 m, and a depth of between 15 and 30 cm. For smaller devices, the box may have height and width values which are both less than 40 cm, and a depth of between 7.5 and 15 cm.

In another exemplary embodiment, a hand-held device may be provided wherein the box will typically have height and width values which are both between 4 and 10 cm, and a depth of between 1 and 4 cm.

However, larger cases of up to, for example, 3 to 5 meters, in height and width, may also be possible, and are not inconsistent with exemplary embodiment of the present disclosure. These larger cases may have a depth of between 15 and 30 cm, and may be provided as cases which may be moved from one exhibition site to another as a single structure.

However, the general techniques for providing the simulated 3D visualizations, in keeping with exemplary embodiments of the present disclosure, will also apply to structures which employ the same principle hardware and software, but which may be more or less permanently installed in such locations or devices such as a theatre, an outdoor display, or television studio. Scalability therefore allows the system to be used in a wide variety of situations, and as such, one feature of a certain aspect of an exemplary embodiment of the present disclosure is that the apparatus is scalable. That is, the apparatus may vary in size from perhaps that of a computer, to the size of a small trailer. For even larger applications, the exemplary apparatus described in the present disclosure may be configured so as to be used on a stage such as might be found in a theatre, conference center, or the like.

While the device consistent with exemplary embodiments of the present disclosure is described as typically comprising only two display devices, additional transparent display devices may be positioned between the front and background display devices. Commonly the number of additional transparent display devices may be between 1 and 10. In an exemplary embodiment, when used, the number of additional transparent display devices may be between 1 and 3.

A problem with prior art approaches is the creation of a moire effect, as previously discussed. While the use of higher resolution display devices (e.g. 4K display screens) may reduce this effect, this approach is not always cost effective. Instead, in the practice consistent with exemplary embodiment of the present disclosure, the low profile simulated 3D display device may also include a moire artifact reduction screen. This screen may typically be a film or panel made of a polycarbonate, such as Lexan™, and may preferably be located between the front display panel, and the background display panel. These screens are essentially transparent panels or films, such as a light control film (LCF), which is an optical film that is configured to regulate the transmission of light. Various LCFs are known, and typically include a light transmissive film or panel having a plurality of parallel grooves.

When positioned between the front and background panels, the moire artifact reduction screen reduces or eliminates the observed moire effect, and thus improves the overall image quality.

In an exemplary embodiment, the first program material and the second program material may be edited and synchronized one with the other so that the images from the background display device may appear to be interrelated to, or merge into, the program material on the front display device, and thus provide a simulated 3D viewing experience. The images of the first program material and the images of the second program material may, however, also be independent.

In an exemplary embodiment, though, the images of the first program material and the images of the second program material may be synchronized. Typically, synchronization of the first program material and the second material may preferably be under the control of a computer, or some other computerized device. Synchronization of the images moving from display device to display device, may be provided by this arrangement.

Synchronization of the images may typically be accomplished in a manner wherein images from the first program material and/or the second program material are altered or edited, in such a manner so that any chosen image from first program material displayed on the front display device, will create an image which will appear to be aligned with an area of the second program material presented on the background display device. In a preferred arrangement, the first program material will appear to be superimposed, or in front of, the edited second program material on the rear screen.

In one exemplary arrangement, the second program material may be altered so that no image is provided in the area behind the image provided in the first program material. As such, the first program material image may be provided without any image from the second program material being superimposed on, or under, the first program image.

Still further, the editing and placement of the first program material image and the edited area of the second program material image may be such that the chosen image of the first program material and the edited area of the second program material may be made to move in any direction, relative one to the other, from frame to frame of the virtual image and the second program material image. As such, the directions of movement from frame to frame of the virtual image, and the edited area of the second program material image may be in opposite directions, so as to provide an enhanced illusion of movement one with respect to the other.

Editing and placement of the second program material on the background display device might also be required to address the non-linear nature of the background display device, and/or the non-parallel or non-planar positioning of the second display device.

Other options to control the interrelated appearance of the combined visual images may be further controlled, and synchronized. For example, there is typically a transparency value which is associated with any color. In a projection based system, the color black is 100% transparent, in terms of the image projected from the display device. The color white is essentially opaque, with the other colors being in between. In contrast, however, for a transparent LCD monitor, a 100% white level is transparent, revealing the background display, and a 100% black level would be essentially opaque, which would conceal the background image.

In either exemplary approach however, transparency of colors may result in problematic imagery when multiple planes of visualization are employed. For example, imagery in the background display device will be revealed in any transparent area in the front display device with the result that the image gives the impression of being “ghostly”.

However, these shortcomings may be overcome or ameliorated by controlling the opacity and luminance levels of the front display device, and/or by using techniques such as providing “traveling mattes” on the rear screen. To be more specific, adjusting the opacity and luminance values of the background display or the front display, with respect to each other, may improve the perceived image parallax and the foreground image fidelity, of the system. In that regard, it is typically preferred, but not essential, that the background opacity should be adjusted to between 20% and 40% of the foreground layer so as to achieve a well perceived three dimensional effect.

The use of traveling mattes may be achieved physically, but in most cases, is done by editing the image content using a computer application. Essentially, a traveling matte may be an artificial black mask that is a “cut-out” of the foreground imagery, and which is applied to the corresponding background plane. This results in a significant improvement to the overall effect. Obviously, the masks which are applied to the background imagery are synchronized to, and in traveling time with, the foreground imagery, and are sized so as to approximate the size of the foreground image. Typically, the matte may be between 80 and 120% of the size of the foreground image.

Overall, the creation of various content aspects in accordance with exemplary embodiments of the present disclosure, including, for example, parallax, relative opacity, luminance, travelling mattes, and the like, acts to provide an improved and enhanced simulated 3D experience. In exemplary embodiments consistent with the present disclosure, this content creation is achieved through editing, synchronizing and/or interrelating the virtual image (or images) to the background image.

Typically, the background panel is parallel to, and co-planar with the front display panel, and is essentially the same size as the front display panel. However, either display panel may be non-linear (e.g. curved), and either panel may extend beyond the sides of the other panel. In one preferred embodiment, the background panel is curved, and extends beyond the sides and/or the top and bottom, of the front panel so that a user viewing the front panel at an angle, will still view an image at the outer edge of the background panel.

When this option is used, preferably, the background panel extends at least 5% beyond the edge of the front display device (based on the width of the front display device). More preferably, the background display device extends at least 10%, and more preferably, at least 20% beyond the side edges of the front display device.

In an embodiment, the background display device extends beyond the front display device on at least two sides, but extending the background display beyond the edges of the front display device, on all four sides is not excluded from being consistent with exemplary embodiments of the present disclosure. As such, in one embodiment, the front display device is a given size of display panel, and the background display panel is selected so as to larger than the front display panel, and thus extend beyond the edges of the front display panel.

In another embodiment, the background panel may be curved or angled such that the outer edges of the background panel extend towards an extended plane of a flat front display panel. As such, the background display may be a curved panel display device, wherein at least the edges of the display device may be curved towards the extended plane of the front display panel, but more preferably, the background display is provided as a flexible display device which is placed so as to provide a continuously curved display panel behind said front display device.

The background display may also be comprised of a plurality of panels configured to provide a suitable display. As examples, the background display could be a flat panel display device which is parallel to the front panel, and also having additional background display panels at its edges which are angled towards the extended plane.

The background display device might also be two flat panel display devices, both angled with respect to the front display panel, wherein the outer edges of the background display devices extend towards the extended plane.

The background display devices may have at least a portion that extends towards the extended plane of the front display device. As a result, the edges of the background display device extends towards the extended plane of the front display by a distance which is at least 25% of the maximum distance between the front and background display devices. More preferably, the background device display devices extend to at least 50%, and more preferably, at least 75% of the maximum distance of between the front and background display devices.

In some embodiments, the edges of the background display devices may extend so as to essentially intersect the extended plane of the front display panel, and thus, the background display devices extend 100% of the maximum distance between the front and background display devices.

The front and background display device may be vertically orientated with respect to the viewer, although this is not required. Moreover, the background display device is preferably vertically aligned, in at least one direction, with respect to the front display device. Thus, in one direction (e.g. up and down), the background display device is a constant distance from the front display panel, even though in another direction (left and right) the distance between the front and background display devices, is changing.

The background display device may also extend beyond, and be curved, towards the front display device, on all four sides. This may be accomplished by, for example, having a background display device with a central panel, which is surrounded by four display devices angled towards the extended plane of the front display device.

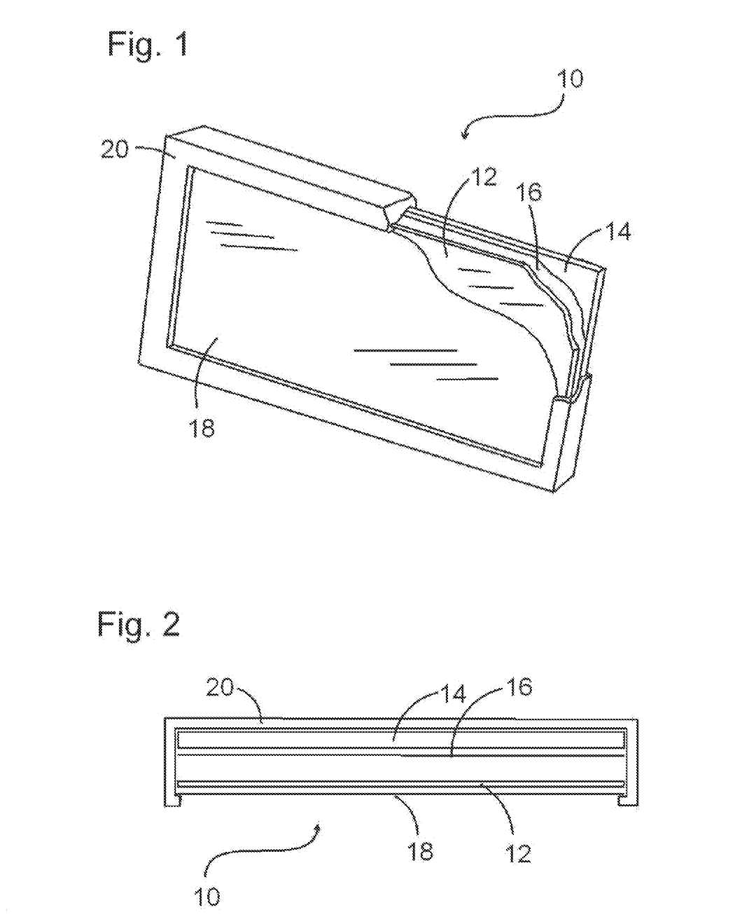

Referring to FIGS. 1 and 2, display device 10 of an exemplary embodiment of the present disclosure is shown having a front display panel 12, a background display panel 14, and a moire reduction screen 16 positioned between front display panel 12 and background display panel 14. An optional transparent protective panel 18 may be positioned directly in front of front display panel 12, so as to avoid or minimize damage to panel 12.

Display device 10 is housed in a cabinet 20, which cabinet may be made of any suitable material for housing display device 20. As such, cabinet 18 may be made of plastic, metal, wood, or the like.

Front display panel 12 may be a transparent LCD display, which has no inherent emissive light qualities. In panel 12, as a transparent display, the color black may create complete 100% image opacity, while the color white may create complete 100% image transparency. As such, varying degrees of video image gray scale between 100% black and 100% white may provide transparency and perceived level of visual depth between the foreground image plane and rear background image plane.

In an embodiment, the display resolution may be 1920×1080, and may have a matched polarization system which is paired with the rear video display. In this embodiment, the display color/gray scale visual data bit depth may be 8 bits or greater per RGB channel.

In an exemplary embodiment, panel 12 may have a width of 1.5 meters, a height of 1 m, and a thickness of 2 cm. Background panel 14 also may have a width of 1.5 meters, a height of 1 m, with a thickness of 5 cm. Panel 14 may be a high-brightness video display having a display brightness of 2000 maydelas per square meter. The display may have a display resolution of 1920×1080, and may have a matched polarization system which is paired with the transparent front display 12. In this embodiment, the display color/gray scale visual data bit depth may be 8 bits or greater per RGB channel.

The distance between front display panel 12 and background display panel 14 may be 8.5 cm, giving an overall thickness of display device 10, of 14 cm.

It should be noted that front panel 12 and background panel 14 may be displays having any suitable resolution. This includes the 1920×1080 mentioned above, but might also be any acceptable resolution, including for example, 3840×2160, UHD, 4K, 8K, and the like.

Moire reduction screen 16 may be a 2 mm screen made of Lexan, and may be positioned 3 mm in front of background display panel 14.

Display device 10, and optional protective panel 18 may be positioned within cabinet 20. Cabinet 20 may also include a secure mounting chassis (not shown) which holds the system power, and display system video signal processing controls. The display device 10 may be connected to a playback engine (not shown), which provides the synchronized foreground and background audio and video content needed to create the 3D viewing experience. The software used to control the images produced, may be proprietary, or standard video display software, which optionally could be customized.

Signals to the front display panel 12 and the background display panel 14, may be transmitted to display device 10 separately using any suitable video transfer equipment. These signals may be provided from an external source, or provided by an on-board system which may be remotely programed, by for example, WiFi, or Bluetooth™ technologies. In an embodiment, however, the signal transmitted to display device 10 may be provided using any acceptable video display codec, such as, for example, a High Efficiency Video Coding (HVEC) codec, which is capable of incorporating and processing the separate video signals to be sent to the front and background display panels. As a result, the video signal may be a single file that is converted to control and provide signals to both the front panel and the background panel.

Other embodiments incorporating various modifications and alterations may be used in the design and manufacture of the apparatus consistent with exemplary embodiments of the present disclosure without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “front”, “back”, “vertical”, “horizontal”, “up”, “down”, and “side-to-side” are used in a relative sense to the normal orientation of the apparatus.

What is claimed:

1. A low profile, simulated 3D display device comprising a front display device comprising a transparent front display device, arranged to display a first image of a first program material which is to be observed by a viewer, and a background display device arranged to display a second image of a second program material which is to be observed by a viewer, wherein said front display device and said background display device are separated to provide an apparent parallax effect between said first image and said second image, and wherein said background display device is a high-brightness video display device.

2. A low profile, simulated 3D display device as claimed in claim 1 wherein said high-brightness display device has a brightness of at least 1500 maydelas per square meter.

3. A low profile, simulated 3D display device as claimed in claim 1 wherein said high-brightness display device has a brightness of at least 1750 maydelas per square meter.

4. A low profile, simulated 3D display device as claimed in claim 1 wherein said high-brightness display device has a brightness of at least 2000 maydelas per square meter.

5. A low profile, simulated 3D display device as claimed in claim 1 wherein said high-brightness display device is a flat panel display device.

6. A low profile, simulated 3D display device as claimed in claim 5 wherein said flat panel display device is an LCD, plasma, LED, or OLED display.

7. A low profile, simulated 3D display device as claimed in claim 1 wherein said front display device is a flat panel, transparent LCD display device.

8. A low profile, simulated 3D display device as claimed in claim 1 wherein said front and background display panels have a height and width of 1 to 2 meters, and the distance between the panels is between 2.5 and 20 cm.

9. A low profile, simulated 3D display device as claimed in claim 8 wherein the distance between the panels is between 5 and 10 cm.

10. A low profile, simulated 3D display device as claimed in claim 1 additionally comprising a moire artifact reduction screen located between said front display device and said background display device.

11. A low profile, simulated 3D display device as claimed in claim 10 wherein said moire artifact reduction screen is a polycarbonate film or panel.

12. A low profile, simulated 3D display device as claimed in claim 1 additionally comprising additional transparent display devices positioned between the front and background display devices.

13. A low profile, simulated 3D display device as claimed in claim 12 comprising between 1 and 3 additional transparent display devices.

14. A low profile, simulated 3D display device as claimed in claim 1 wherein said first program material and the second program material are edited and synchronized one with the other so that the images from the background display device appear to be interrelated to, or merge into, the program material on the front display device, and thus provide a simulated 3D viewing experience.

15. A low profile, simulated 3D display device as claimed in claim 1 wherein said background panel is parallel to, and co-planar with said front display panel, and is essentially the same size as the front display panel.

16. A low profile, simulated 3D display device as claimed in claim 1 wherein video signals are transmitted to said front display panel and said background display panel using a video display codec, which is capable of incorporating and processing the separate video signals to be sent to the front and background display panels.

17. A low profile, simulated 3D display device as claimed in claim 1 wherein said video display codec is a High Efficiency Video Coding (HVEC) codec.
